(19) United States
(12) Patent Application Publication
(10) Pub. No.: US 2025/0389368 A1
(43) Pub. Date: Dec. 25, 2025

(54) QUICK-CONNECT HANDLE

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/241,885

(22) Filed: Jun. 18, 2025

(30) Foreign Application Priority Data
Jun. 20, 2024 (CN) 2024214210822

(51) Int. Cl. F16M 11/04; G03B 17/56

(52) U.S. Cl. CPC F16M 11/041; G03B 17/563; F16M 2200/02

(57) ABSTRACT

A quick-connect handle for rapidly connecting a tripod head includes an installation housing, a locking member, and an adjustment assembly. The installation housing has an installation hole for receiving a head screw and an adjustment cavity inside that communicates with the installation hole. The locking member is rotatably installed within the adjustment cavity and has a through-hole that communicates with the installation hole and receives the head screw. The through-hole further includes a locking hole with locking threads on its inner wall, which are configured to engage with the head screw. The adjustment assembly rotates the locking member such that the locking threads can move toward or away from the head screw. The locking member is adjusted and rotated by the adjustment assembly, enabling the installation hole to communicate or align with either the locking hole or the through-hole.

### CROSS-REFERENCE TO RELATED APPLICATIONS

The present application for patent claims priority to and the benefit of pending Chinese Application No. 2024214210822, filed Jun. 20, 2024, and hereby expressly incorporated by reference herein as if fully set forth below in its entirety and for all applicable purposes.

### TECHNICAL FIELD

This disclosure pertains to the field of camera equipment, specifically to a quick-connect handle.

### INTRODUCTION

With technological advancements and improvements in people's living standards, the use of video cameras and still cameras have become increasingly prevalent. Cameras utilized during filming are often equipped with various accessories, such as tripods. Currently, when using a camera for filming, it is common practice to mount it on these accessories.

Examples of existing camera accessories typically include a tripod head, a camera support for holding the tripod head, and a connection handle that is detachably connected to the tripod head. The connection handle serves to lock the tripod head to the camera support. In the current state of the art, the connection handle is commonly designed as a connector with threaded holes, while the tripod head generally features an adjustable ball socket with head screws. The tripod head is installed by threading the head screws into the connection handle.

According to the aforementioned technical solution in the prior art, when installing the tripod head, the connection handle is twisted upward from the bottom of the head screw, necessitating a long thread engagement length for proper locking. Similarly, during disassembly, reverse rotation is required, which also involves a long rotation range. As a result, the installation and disassembly processes of the head are relatively time-consuming.

### BRIEF SUMMARY

Aspects of the present disclosure present a quick-connect handle to facilitate efficient installation and disassembly of a tripod head.

According to aspects of the disclosure, a quick-connect handle for rapidly connecting a tripod head, including:
an installation housing having an installation hole for inserting a head screw, and an adjustment cavity inside the installation housing that communicates with the installation hole;
a locking member movably provided within the adjustment cavity; the locking member has a through-hole that communicates with the installation hole and allows the insertion of the head screw; the through-hole includes a locking hole with locking threads on its inner wall, which are configured to engage with the head screw; and
an adjustment assembly for rotating the locking member such that the locking threads can move toward or away from the head screw.

### BRIEF DESCRIPTION OF THE DRAWINGS

FIG. 1 is a diagram illustrating a quick-connect handle according to some aspects of the disclosure;

FIG. 2 is a diagram illustrating an exploded view of the quick-connect handle according to some aspects of the disclosure;

FIG. 3 is a diagram illustrating a state of a locking member under an action of an elastic member according to some aspects of the disclosure;

FIG. 4 is a diagram illustrating a cross-sectional view along a vertical direction of FIG. 3;

FIG. 5 is a diagram illustrating a partial cross-sectional view of the quick-connect handle according to some aspects of the disclosure;

FIG. 6 is a diagram illustrating a state of a locking member during unlocking according to some aspects of the disclosure;

FIG. 7 is a diagram illustrating a cross-sectional view along a vertical direction of FIG. 6;

FIG. 8 is a diagram of a tripod head according to some aspects of the disclosure.

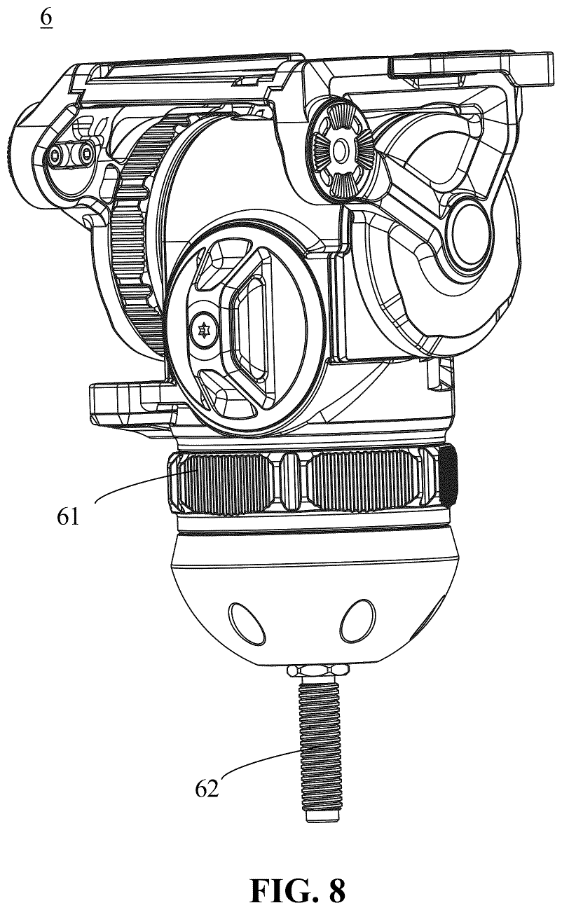

Reference numbers: 1, installation housing; 11, installation hole; 12, adjustment cavity; 121, first inner wall; 122, second inner wall; 13, first housing body; 14, second housing body; 15, stepped shaft; 2, locking member; 21, through-hole; 22, locking hole; 23, locking threads; 24, installation groove; 3, adjustment assembly; 31, elastic member; 311, spring; 312, limit groove; 313, limit protrusion; 32, unlocking member; 321, unlocking part; 322, elongated groove; 323, skidproof stripe; 33, connecting member; 4, tube ring; 5, supporting portion; 51, recess; 6, tripod head; 61, head body; 62, head screw.

### DETAILED DESCRIPTION

Aspects of the present disclosure are further elaborated upon through detailed description in conjunction with the drawings. Similar components across different aspects may be associated with similar component labels. In the following aspects, numerous detailed descriptions are provided to facilitate a better understanding of the present disclosure. However, those skilled in the art can readily recognize that some features can be omitted in various scenarios or replaced with other components, materials, or methods. In some instances, certain operations related to the present disclosure may not be shown or described in the specification to avoid overwhelming the core aspects of the present disclosure with excessive descriptions. For those skilled in the art, a detailed description of these related operations is unnecessary, as they can fully comprehend the related operations based on the specification's description and general technical knowledge in the field.

In some aspects, the features, operations, or characteristics described in the specification may be combined in any suitable manner for various aspects. The sequence of operational steps involved in each aspect may also be rearranged or adjusted in a manner apparent to those skilled in the art. Therefore, the specification and accompanying drawings are merely for the purpose of clearly describing a particular aspect and do not imply that the described components and/or sequence are mandatory.

The numbering of components in this disclosure, such as “first,” “second,” etc., is solely for the purpose of distinguishing the described objects and does not carry any sequential or technical significance. Unless specified otherwise, the terms “connected” and “coupled” as used in this disclosure can encompass both direct and indirect connections (or couplings).

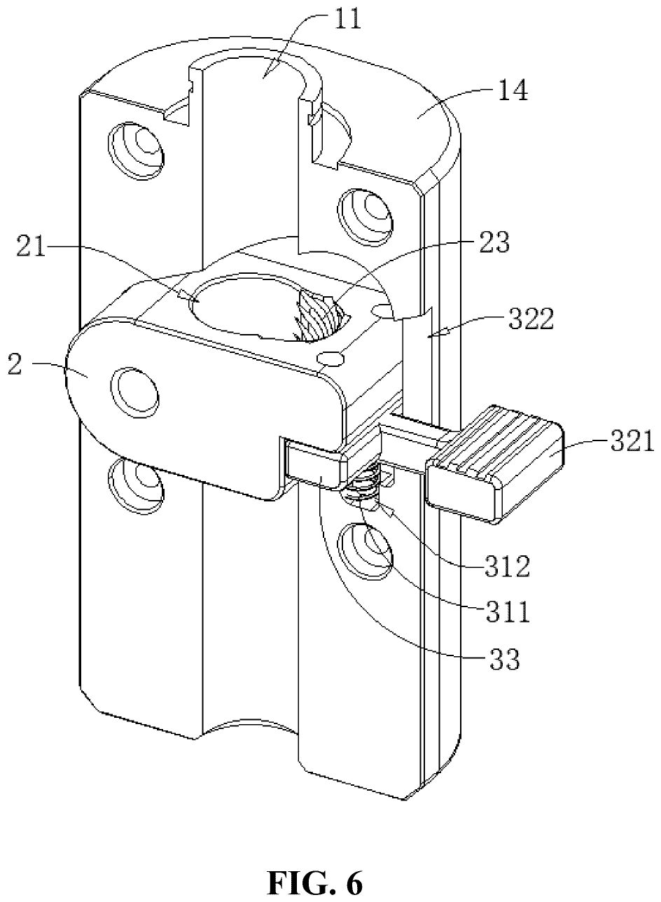

Existing camera equipment typically includes a tripod head 6 (FIG. 6), a camera support for holding the tripod head 6, and a connection handle that is detachably connected to the tripod head 6. The connection handle serves to secure the tripod head 6 onto the camera support. Currently, the connection handle is commonly configured as a component featuring threaded holes. The tripod head 6 includes a head screw 62 and a head body 61. The head body 61 is equipped with a ball socket. An upper end of the head screw 62 is connected to the ball socket, and a lower end is threaded into the connection handle to install the tripod head 6. The specific structure is generally in line with the prior art. In the prior art, when installing the tripod head 6, the connection handle is rotated upward from the bottom of the head screw 62, necessitating a long thread engagement length for proper locking. Similarly, during disassembly, reverse rotation is required, which also involves a long rotation distance. As a result, the installation and disassembly processes of the tripod head 6 are relatively time-consuming.

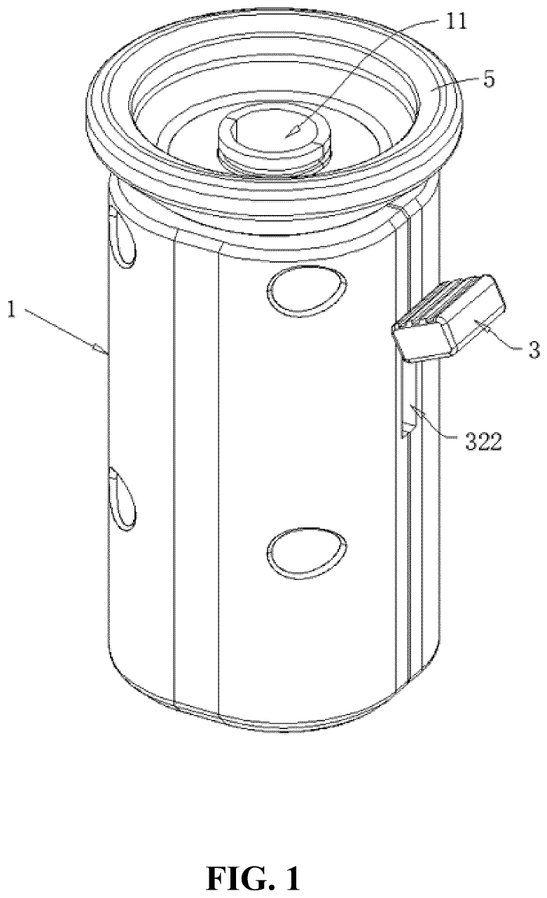

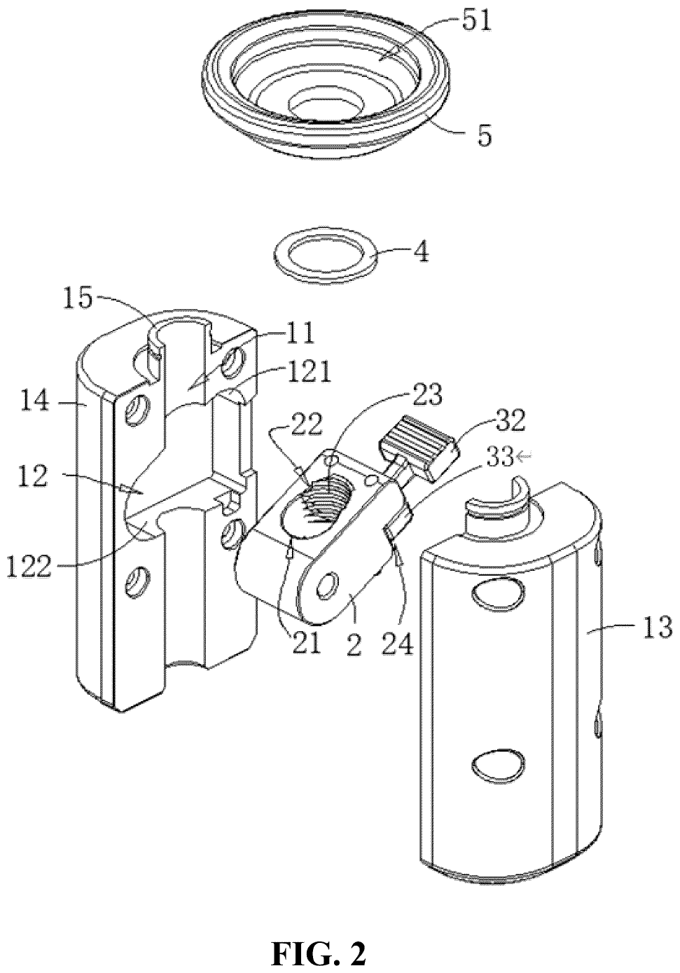

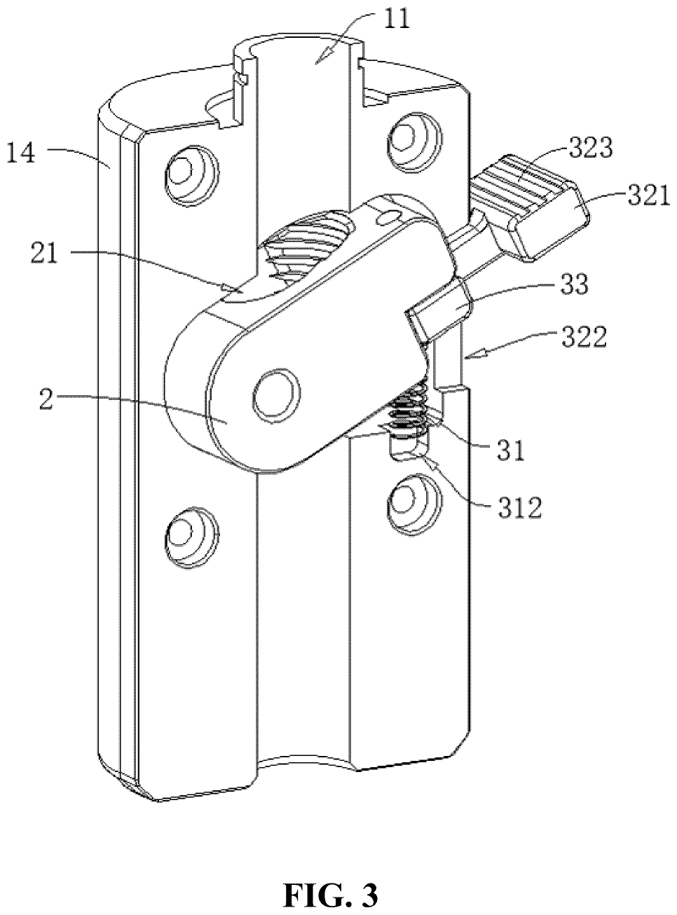

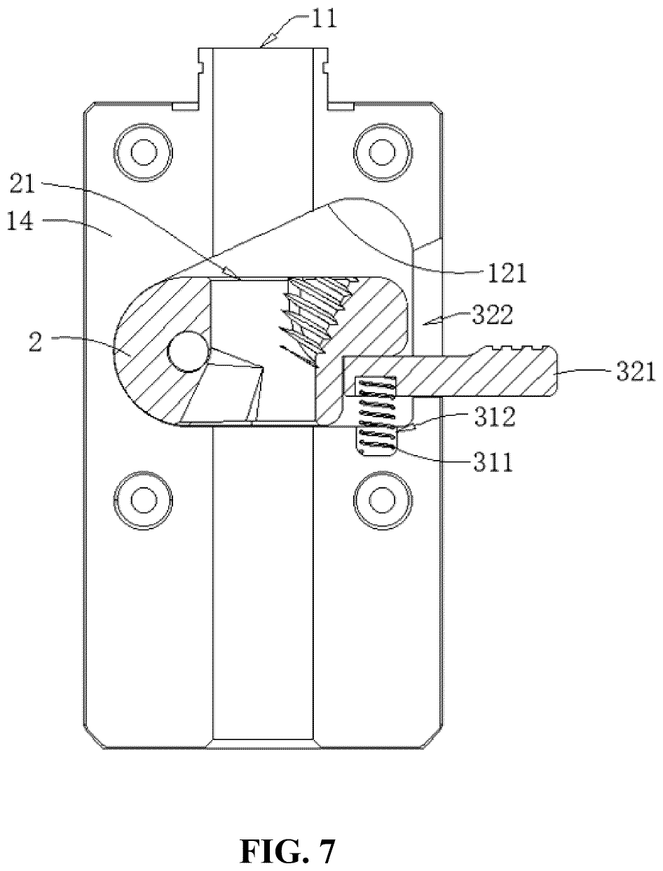

Referring to FIGS. 1-7, the present disclosure presents a quick-connect handle that incorporates an adjustable locking member 2 (e.g., see FIGS. 2 and 3). By moving the locking member 2 to different positions using an adjustment assembly 3, the connection handle can be rapidly provided onto the head screw 62.

In some aspects of this disclosure, a quick-connect handle is provided for quickly connecting the tripod head 6. Referring to FIGS. 1 and 2, the quick-connect handle includes an installation housing 1, a locking member 2, and an adjustment assembly 3. The installation housing 1 is provided with an installation hole 11 for the insertion of the head screw 62, and an adjustment cavity 12 that communicates with the installation hole 11 is located inside the installation housing 1. The locking member 2 is movably provided within the adjustment cavity 12. The locking member 2 has a through-hole 21 that communicates with the installation hole 11 and allows for the insertion of the head screw 62. The through-hole 21 is equipped with a locking hole 22, the inner wall of which is provided with locking threads 23 designed to cooperate with the threads of the head screw 62. The adjustment assembly 3 is used to pivot the locking member 2, enabling the locking threads 23 to move closer to or move farther away from the head screw 62.

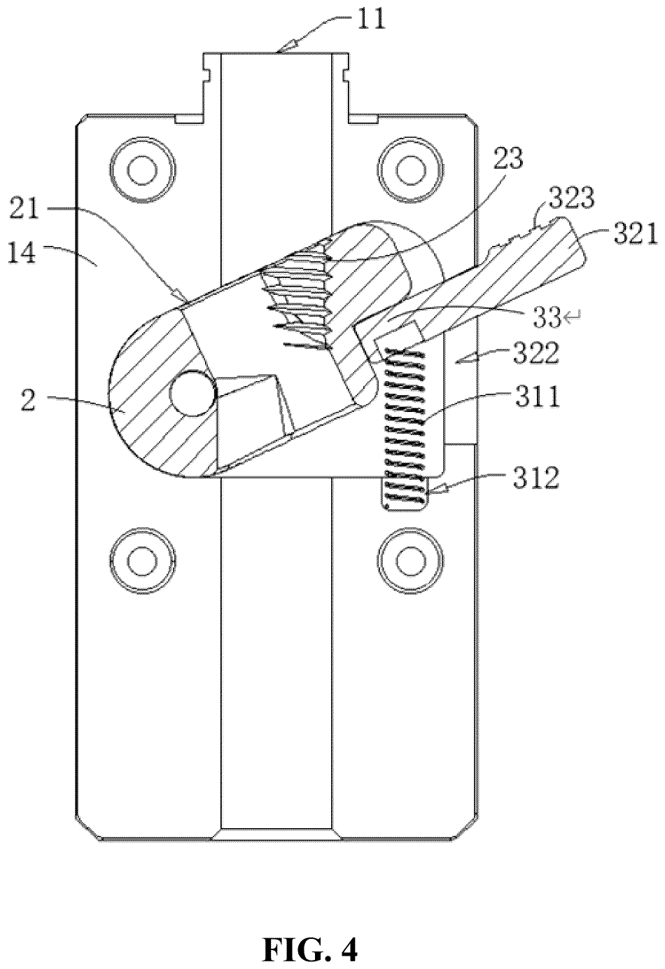

In some aspects, referring to FIGS. 3-4, the locking member 2 can be an integrally formed locking block. Since the locking member 2 is movably connected within the installation housing 1 and adjusted via the adjustment assembly 3, when installing the head screw 62, the connection handle can be provided onto the head screw 62. The lower end of the head screw 62 is inserted into the through-hole 21 and the locking hole 22 through the installation hole 11. The threads of the head screw 62 can gradually cooperate with the locking threads 23. Rotating the connection handle then locks the head screw 62 onto the connection handle. When unlocking is required, the connection handle is first pivoted to release the lock, and then the adjustment assembly 3 is used to pivot the locking member 2 along its pivotable path, causing the locking threads 23 to disengage from the head screw 62, allowing the head screw 62 to be withdrawn. In summary, disclosed the connection handle enables the rapid installation and disassembly of the tripod head 6 via the connection handle without the need for prolonged pivoting of the head screw 62, thereby shortening the locking distance and making the operation simpler, quicker, and more time-efficient.

It is worth noting that, as seen from the perspective of FIG. 4, the right sidewall of the locking hole 22 is provided with the locking threads 23. The through-hole 21 and locking hole 22 are formed in a partially overlapping arrangement.

In some aspects, referring to FIGS. 2-5, the adjustment assembly 3 includes an elastic member 31, a connecting member 33, and an unlocking member 32. The bottom of the locking member 2 is provided with an installation groove 24, in which the connecting member 33 is housed and connected to the wall of the installation groove 24. Specifically, the connecting member 33 is provided with threaded holes and can be fixed to the locking member 2 using screws. The unlocking member 32 is connected to the connecting member 33 and drives the pivoting of the locking member 2 through the connecting member 33. The elastic member 31 is provided between the installation housing 1 and the connecting member 33. The elastic member 31 resets the connecting member 33, thereby resetting the unlocking member 32 and the locking member 2, ensuring that the head screw 62 can cooperate with the locking threads 23. The unlocking member 32 is used to overcome the elastic tendency (e.g., preload) of the elastic member 31 and adjust the pivoting (e.g., angle) of the locking member 2, facilitating the disengagement of the locking threads 23 from the head screw 62 and thus the withdrawal of the head screw 62. In some aspects, when installing the head screw 62, the connection handle is provided onto the head screw 62, and the threads of the head screw 62 cooperate with the locking threads 23. Rotating the connection handle in a locking direction then locks the head screw 62 onto the connection handle. When unlocking is required, the connection handle is first rotated in an unlocking direction to release the lock, and then the unlocking member 32 is actuated. Since the unlocking member 32 is connected to the locking member 2 via the connecting member, it can pivot the locking member 2 to disengage the locking threads 23 from the head screw 62, allowing the head screw 62 to be withdrawn. In summary, this connection handle enables the rapid installation and disassembly of the tripod head 6 via the connection handle without the need for prolonged rotating of the head screw 62, thereby shortening the locking distance and making the operation simpler, quicker, and more time-efficient.

It is worth noting that when the connection handle is provided onto the head screw 62, the connection handle moves upward along the head screw 62, while the locking member 2 is movably provided within the installation housing. Therefore, the force exerted by the head screw 62 during this process can drive the pivoting of the locking member 2, causing the unlocking member 32 to move relatively downward and compress the elastic member 31. Consequently, when installing the quick-connect handle onto the head screw 62, the user does not need to actuate the unlocking member 32; the unlocking member 32 can move downward correspondingly as the connection handle is fitted onto the head screw 62. This arrangement greatly facilitates the user's installation operation. It can be understood that when the connection handle is installed in the appropriate position, the elastic force of the elastic member 31 (e.g., a preloaded spring) can reset the unlocking member 32. In this example, the unlocking member 32 is positioned towards the upper right, facilitating its downward movement. On the other hand, actuating the unlocking member 32 is also convenient for user operation.

Referring to FIGS. 3-7, the axis of the installation hole 11 is vertically oriented, the pivoting axis of the locking member 2 is horizontal and perpendicular to the axis of the installation hole 11, the axis of the locking hole 22 intersects with the axis of the through-hole 21 at a non-zero angle, and the locking threads 23 are disposed on the inner arcuate surface of the locking hole 22 away from the through-hole 21. In the normal state of the locking member 2, due to the elastic tendency (e.g., preload) of the elastic member 31, after the head screw 62 is inserted into the installation hole 11, its threads cooperate with the locking threads 23. Rotating the head screw 62 in a locking direction then locks it with the locking threads 23. When unlocking the head screw 62, the locked state is released by rotating the head screw 62 in an unlocked direction, and the unlocking member 32 pivots the locking member 2, causing the locking threads 23 to move away from the head screw 62, facilitating its withdrawal. By pivoting the locking member 2, the installation hole 11 is aligned with the through-hole 21 or the locking hole 22.

In some aspects, referring to FIG. 2, the adjustment cavity 12 provides a space for the pivoting of the locking member 2 and includes a first inner wall 121 and a second inner wall 122. The first inner wall 121 is the upper end wall of the adjustment cavity 12 near the installation hole 11, and the second inner wall 122 is the lower bottom wall of the adjustment cavity 12. The first inner wall 121 and the second inner wall 122 can limit the adjustment range (e.g., a predetermined rotation range) of the locking member 2.

Referring to FIG. 3, the unlocking member 32 includes an unlocking part 321 (e.g., unlocking lever). An end of the unlocking part 321 is connected to the locking member 2, and the other end extends out of the installation housing 1. The installation housing 1 is provided with an elongated groove 322 (e.g., a slot) for the pivoting of the unlocking part 321. The elongated groove 322 communicates with the adjustment cavity 12 and is oriented along the axis of the installation hole 11. The end of the unlocking part 321 extending out of the installation housing 1 can be provided with a textured surface (e.g., skidproof stripes 323) for easier operation by the user.

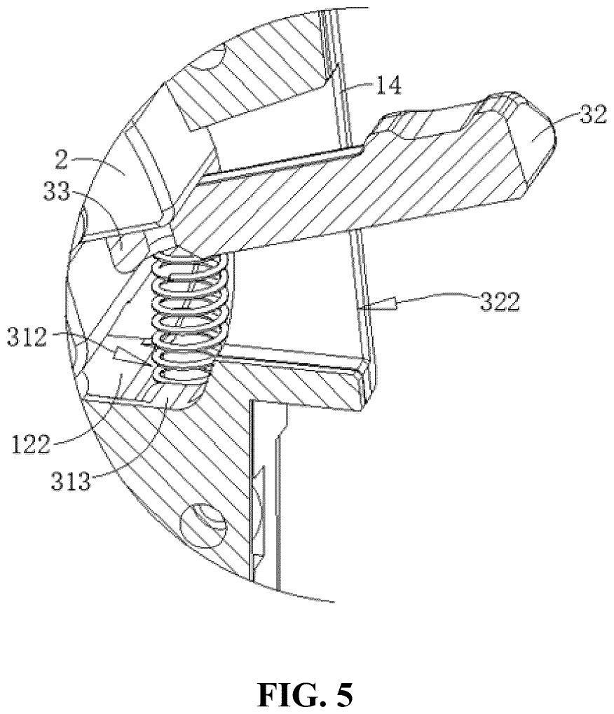

In some aspects of this disclosure, with reference to FIG. 4, the elastic member 31 can include a spring 311, positioned away from the pivoting axis of the locking member 2. The unlocking part 321 is connected to the locking member 2 via the connecting member 33. Both the connecting member 33 and the second inner wall 122 can be equipped with limit grooves 312 for positioning the spring 311. The axis of the spring 311 can be parallel to that of the installation hole 11. The upper end of the spring 311 is housed within the limit groove 312 of the connecting member 33, while the lower end is accommodated and secured within the limit groove 312 of the second inner wall 122. The groove wall of the limit groove 312 on the second inner wall 122 can feature a limit protrusion 313 (FIG. 5) to constrain the elastic member 31, thereby ensuring a reliable connection for the spring 311.

In some aspects, the engagement between the locking threads 23 and the head screw 62 can be substituted with a wedge-block and locking-block structure, or other cooperating structures that achieve clamping through positional differences and release upon pivoting of the locking member 2. When installing the head screw 62, it presses downward to either rotate the locking member 2 or depress the unlocking part 321, moving the wedge block or similar clamping structure away from the head screw 62. Once the head screw 62 reaches its installation position, the elastic force of the spring 311 automatically rotates the locking member 2, causing the locking block to engage with the wedge block, eliminating the need to rotate the tripod head 6 during installation.

Referring to FIG. 2, the installation housing 1 includes a first housing body 13 and a second housing body 14, symmetrically arranged along the axis of the installation hole 11. The first and the second housing bodies 13 and 14 can be fastened together along the radial direction of the installation hole 11 to form the installation hole 11 and the adjustment cavity 12. In one example, they can be locked together using bolts or the likes. When components within the adjustment cavity 12 need to be replaced due to the head screw 62, disassembling the first and the second housing bodies 13 and 14 facilitates maintenance.

As shown in FIG. 2, the upper end of the installation housing 1 is designed as a stepped shaft 15 with a smaller diameter than the lower end of the installation housing 1. A tube ring 4 and a supporting part 5 (FIG. 1) are coaxially provided on the stepped shaft 15 at the upper end of the installation housing 1. The tube ring 4 fastens the first and the second housing bodies 13 and 14 together and is also positioned between the supporting part 5 and the installation housing 1. The supporting part 5 serves to support the tripod head 6, and the side of the supporting part 5 facing away from the installation housing 1 is designed as a recess 51 to support the adjustment ball socket of the tripod head 6.

The above description uses specific examples to elaborate on the present disclosure, which is solely for the purpose of aiding understanding and is not intended to limit the present disclosure. For those skilled in the technical field to which the present disclosure belongs, based on the idea of the present disclosure, several simple deductions, deformations, or substitutions can also be made.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A quick-connect handle for connecting a tripod head, comprising:
an installation housing provided with an installation hole configured to receive a head screw, and the installation housing being internally provided with an adjustment cavity, the adjustment cavity communicating with the mounting hole;
a locking member movably provided within the adjustment cavity, the locking member provided with a through-hole communicating with the installation hole, allowing the head screw to insert,
wherein the through-hole comprises a locking hole, a locking thread provided on an inner wall of the locking hole, and the locking thread configured to cooperate with the head screw; and
an adjustment assembly configured to rotate the locking member in a first direction to move the locking thread toward the head screw, and in a second direction to move the locking thread away from the head screw.

2. The quick-connect handle according to claim 1, wherein the adjustment assembly comprises a connecting member and an unlocking member connected to the connecting member, and
the connecting member is connected to the locking member and is elastically connected to the installation housing.

3. The quick-connect handle according to claim 2, wherein the locking member is provided with an installation groove; and
wherein the connecting member is accommodated within the installation groove and connected to a wall of the installation groove.

4. The quick-connect handle according to claim 2, wherein the adjustment assembly comprises an elastic member disposed between the installation housing and the connecting member; and
wherein the elastic member is configured to drive the connecting member to reset, thereby the unlocking member to reset.

5. The quick-connect handle according to claim 4, wherein the installation housing has a limit groove; and
wherein an end of the elastic member away from the connecting member is provided within the limit groove, and a wall of the limit groove is provided with a limit protrusion to limit the elastic member.

6. The quick-connect handle according to claim 2, wherein the unlocking member comprises an unlocking part;
wherein a first end of the unlocking part is connected to the connecting member, and a second end of the unlocking part extends out of the installation housing; and
wherein the installation housing is provided with an elongated groove configured to enable the unlocking part to rotate.

7. The quick-connect handle according to claim 1, wherein an end of the installation housing is provided with a supporting part, the supporting part is configured for supporting the tripod head, and a side of the supporting part away from the installation housing is provided with a recess configured to support the tripod head.

8. The quick-connect handle according to claim 1, wherein the installation housing comprises a first housing body and a second housing body; and
wherein the first housing body and the second housing body are connected along a radial direction of the installation hole to form the installation hole and the adjustment cavity.

9. The quick-connect handle according to claim 8, wherein a pivoting axis of the locking member is perpendicular to an axis of the installation hole; and
wherein an axis of the locking hole intersects an axis of the through-hole at a non-zero angle, and the adjustment assembly is configured to drive the locking member to pivot around the pivoting axis.

10. The quick-connect handle according to claim 1, wherein the adjustment cavity comprises a first inner wall and a second inner wall, and the first inner wall and the second inner wall are configured to limit the locking member to a predetermined rotation range.
